(19) United States
(12) Patent Application Publication
(10) Pub. No.: US 2015/0058079 A1
(43) Pub. Date: Feb. 26, 2015

(54) DETECTING TRENDS FROM IMAGES UPLOADED TO A SOCIAL NETWORK

(71) Applicant: Google Inc., Mountain View, CA (US)

(72) Inventors: Martin Brandt FREUND, Mountain View, CA (US); Yuanying Xie, Mountain View, CA (US)

(73) Assignee: Google Inc., Mountain View, CA (US)

(21) Appl. No.: 14/010,428

(22) Filed: Aug. 26, 2013

(51) Int. Cl. G06Q 30/02; G06Q 50/00

(52) U.S. Cl. CPC G06Q 30/0202; G06Q 50/01
USPC 705/7.31

(57) ABSTRACT

A system and method is disclosed for detecting marketable subjects within digital images uploaded to the social network. Software associated with a social network detects a marketable subject in a plurality of images provided to a social stream by a group of users who share a relationship in the social network. A popularity of the marketable subject within the group of users is determined based on the detecting, and a current trend is identified for the group of users based on the popularity and a relevant time period for the images. A vendor related to the marketable subject may be notified that the current trend applies to one or more of the group of users.

### BACKGROUND

Online social networks allow users to interact with each other by posting and sharing digital images within various message feeds. Users often upload digital images that capture items and products that are of interest to themselves or other users. An image of one user's self is more likely to accurately depict what that types of apparel or fashion that the user is interested in than a message because the image depicts the user actually wearing the apparel. Users may also view images of their friends in the social network and comment on what their friends are wearing. Whether or not a user chooses to comment on apparel depicted in images uploaded by other users, it is possible that the user may be influenced by the apparel depicted in the images.

Additionally, social networks provide product manufacturers the ability to target consumers who would likely be interested in their brands based on demographics collected from the social network. However, demographics alone cannot determine the authenticity of individual consumer interest in a particular brand or product, or determine how the consumer's interest might be influenced by other users of the social network.

### SUMMARY

The subject technology provides a system and computer-implemented method for detecting marketable subjects within digital images uploaded to the social network. According to one aspect, a computer-implemented method may include detecting a marketable subject in a plurality of images provided to a social stream by a group of users who share a relationship in a social network, determining, based on the detecting, a popularity of the marketable subject within the group of users, identifying, for the group of users, a current trend based on the popularity and a relevant time period for the images, and notifying a vendor related to the marketable subject that the current trend applies to one or more of the group of users. Other aspects include corresponding systems, apparatuses, and computer program products for implementation of the computer-implemented method.

In another aspect, a machine-readable medium may include instructions stored thereon that, when executed by a processor, cause a machine to perform a method of detecting marketable subjects within digital images uploaded to the social network. In this regard, the method may include detecting a plurality of marketable subjects in a plurality of images uploaded to a social network, the images uploaded by a group of users who share a relationship in the social network, identifying, for the group of users, a current trend associated with a detected marketable subject based on a threshold number of instances of the detected marketable subject associated with the group, and notifying a vendor related to the detected marketable subject that the current trend applies to one or more of the group of users. Other aspects include corresponding systems, apparatuses, and computer program products for implementation of the machine-readable medium.

In a further aspect, a system may include one or more processors and a memory. The memory may include instructions that, when executed by the one or more processors, cause the one or more processors to facilitate the steps of detecting a marketable subject in a plurality of images provided to a social stream by a group of users who share a relationship in a social network, determining, based on the detecting, a popularity of the marketable subject within the group of users, identifying, for the group of users, a current trend based on the popularity and a relevant time period for the images, and notifying a vendor related to the marketable subject that the current trend applies to one or more of the group of users.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

A detailed description will be made with reference to the accompanying drawings:

FIG. 1 is a state flow diagram depicting example processes for detecting trends from images uploaded to a social network.

FIG. 2 is a flowchart illustrating an example process for detecting trends from images uploaded to a social network.

FIG. 3 is a diagram depicting example users of a social network that have uploaded images associated with one or more brands.

FIG. 4 is an example table of current trends and trending apparel for a prototype user of a social network.

FIG. 5 is a diagram illustrating an example electronic system for use in connection with detecting trends from images uploaded to a social network.

### DETAILED DESCRIPTION

The subject technology provides a mechanism within a social network that automatically detects marketable subjects (e.g., brands, products or services offered by a vendor) within digital images uploaded to the social network. When a digital image is uploaded, image recognition software is configured to recognize an item within the image that corresponds with a known brand, product, or service, and associate the user of the social network who uploaded the image with the identified marketable subject in a database. A brand, product or service may also be identified from meta data embedded within the uploaded image. Accordingly, the system of the subject technology identifies common marketable subjects between users who share a relationship in the social network (e.g., who are connected as “friends” in a social graph or otherwise associated by common interests), and the popularity of those marketable subjects within groups of users.

For a group of related users, a current trend associated with a detected marketable subject may be identified based on a threshold number of uploads related to the detected marketable subject within the group. A trend associated with a marketable subject may be identified, for example, when the number of images that include the marketable subject is uploaded by a majority of users within a particular group, or uploaded within a predetermined window of time. In this regard, the system may compare a timestamp associated with the image, or the time that the image is uploaded, with dates and times of other recently uploaded images to determine whether detectable subjects within the image correspond to a developing or ongoing trend.

Once a current trend has been identified, the system may notify a vendor related to the detected marketable subject of the trend. In some aspects, the system may determine that the current trend comprises a change in an initial trend, and notify the vendor in response to the change. Additionally or in the alternative, the system may generate or direct an offering (e.g., an advertisement) to one or more users associated with a current trend in response to detecting the current trend or change in a trend.

The relevance of a trend detected from uploaded images may also be determined, and the trend adjusted based on the determined relevance. For example, a trend for a user or group of users may be adjusted based on the closeness of the relationship between the users, or the prevalence of the corresponding marketable subject in images available for viewing by a respective user. In this regard, the relevance may indicate how strong the trend applies to a particular user. For example, a trend relating to soccer jerseys within a group of users may not be applicable to a user of the group who has not expressed any explicit interest in soccer (e.g., by prior postings or by analyzing pictures of the user). A trend relating to users of a group attending a particular business establishment may not be applicable to a user of the group who is not located in the same city as the business establishment.

The system further facilitates targeted marketing to users of the social network based on trend criteria, including the detected trends and the relevance of those trends to specific users. A value may be set for vendors to provide offerings to users based on the trend criteria. For example, the value may increase and decrease commensurate with an increase or decrease in the popularity of a trend and its relevance to a user or group of users. The value may increase when a new trend is detected, as it may indicate early adoption of a corresponding marketable subject and provide a vendor the opportunity to escalate the possibility of the marketable subject going viral through targeted offerings by the vendor.

In a further aspect, the system may detect apparel within uploaded images and maintain a “prototype” user for the purpose of identifying fashion trends for the prototype user. The most popular piece of apparel for each part of the anatomy may be stored (e.g., as a database table). Trends associated with types of clothing for each part of the anatomy may be identified so that trends identified for specific brands do not overlap for each article of clothing.

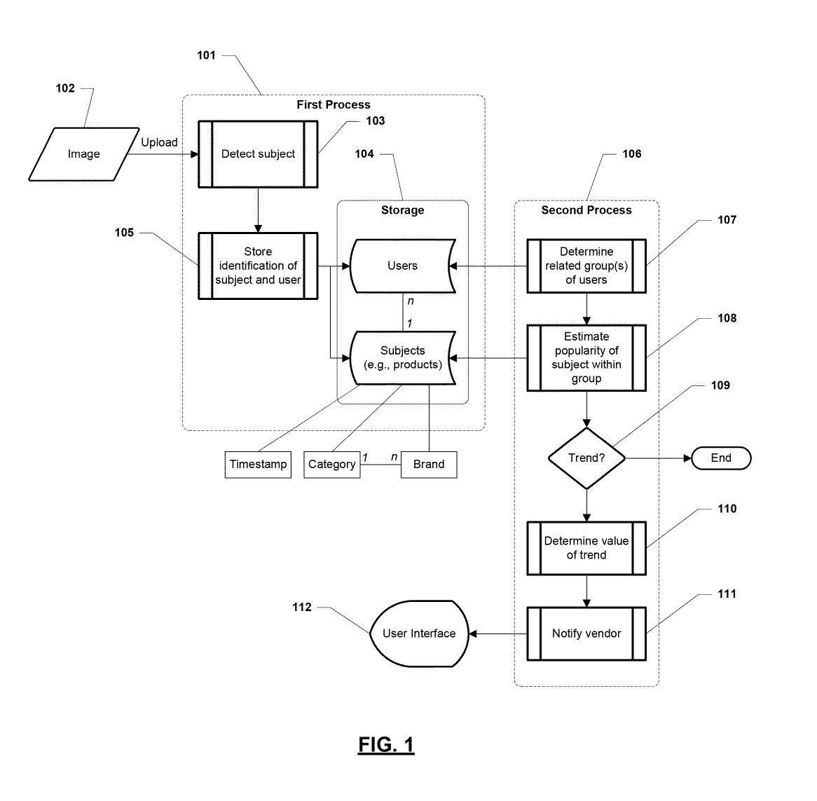

FIG. 1 is a state flow diagram depicting example processes for detecting trends from images uploaded to a social network, according to some aspects of the subject technology. The blocks of FIG. 1 do not need to be performed in the order shown. It is understood that the depicted order is an illustration of one or more example approaches, and are not meant to be limited to the specific order or hierarchy presented. The blocks may be rearranged, and/or two or more of the blocks may be performed simultaneously.

According to one or more implementations, one or more blocks of FIG. 1 may be executed by one or more computing devices. The computing devices may host or operate in connection with one or more social networks. In this regard, a non-transitory machine-readable medium may include software or machine-executable instructions thereon that, when executed by a computer or machine, perform the blocks of FIG. 1. Accordingly, the blocks of FIG. 1 may be performed in association with a social network.

A first process 101 may execute in a social network to monitor social stream activity for one or more users, and to detect and analyze images that are uploaded to the social network by users for display within the social stream. Accordingly, first process 101 analyzes an image 101 to determine the presence of known marketable subjects within the image. First process 101 may analyze images at the time they are uploaded, or may periodically analyze previously uploaded images.

A marketable subject includes, for example, a specific brand identity for a product or service, a particular style of clothing or piece of apparel (e.g., jeans, shoes, boots, purses, or the like), or identity of a business establishment. First process 101 may use various techniques to detect 103 a marketable subject within image 101. For example, first process 101 may implement computer vision to determine whether or not the image data contains some known specific object, feature, texture, or activity.

In various aspects, a predetermined catalog of marketable subjects may be stored in a database or similar storage location 104 and indexed by a sub-process during computer vision analysis. In other aspects, a sub-process may implement optical character recognition to identity one or more names within an image and, once identified, index storage location 105 by the name or other identification to determine whether the recognized characters correspond to a known marketable subject. First process 101 may also identify known marketable subjects within meta-data embedded within an uploaded image.

Once a marketable subject has been identified, first process 101 associates the marketable subject, the image, and the user who uploaded the image. The association may then be stored 105 in storage location 104. Accordingly, storage location 104 may include relationships between multiple users and marketable subjects. For example, if multiple products are stored, each product may be associated with one or more users. In some implementations, a marketable subject may include multiple levels of association. For example, a product may be associated with a product category and a brand, with multiple brands being associated with each product category. In one example, a specific type of shoe may be in the category “shoes” and be made or sold by one or more brand manufacturers.

First process 101 continues to associate users with marketable subjects as images are uploaded to the social network. When an association is made (e.g., within storage location 104), first process 101 identifies or generates a timestamp for the image so that the relevancy of marketable subjects within the image to current trends may be determined. In one example, a timestamp representative of when the image was taken may be embedded with other meta data in the image. This timestamp may then be identified from within the image by first process 101. In another example, the timestamp may be generated based on the time and/or date that the image was uploaded to the social network by the user.

A second process 106 may access storage location 104 to identify a current trend associated with a detected marketable subject. In various aspects, the current trend may be identified for one or more groups of users based on, for example, a threshold number of image uploads related to the detected marketable subject within the one or more groups. Accordingly, second process 106 may access storage location 104 to determine 107 a group of users based on predetermined criteria. For example, a group may be determined based on a relationship between the users. In this regard, the relationship may be determined with respect to a particular user when the user uses the social network.

Additionally or in the alternative, the relationship between users in a group may be determined based on a common interest. Second process 106 may determine one or more interests of each of the users based on information provided by the users to the social network, and then determine the common interest based on the provided information. Information provided by users may be based on social stream activity. For example, second process 106 may determine a relationship based on endorsements of the same or similar posts or content within one or more social streams, viewing of the same or similar posts or articles or advertisements, and the like. In various aspects, a relationship between one or more users may be based on a social connection made between the users. For example, the users may have added each other as “friends,” one user may be following another user, may have corresponded through email or other messaging, or the users may be within a certain degree of separation within the social network.

Once a group is determined, second process 106 may estimate 108 the popularity of a marketable subject within the group. For example, second process 106 may determine how many images or messages containing the marketable subject were uploaded by users in the group, how many of the images or messages were endorsed or viewed by users of the group, how many of the users endorsed or viewed an image or message or advertisement related to the marketable subject (e.g., within or outside the group), how many of the users of the group generated activity, including endorsements or views, related to the marketable subject, and the like.

When analyzing instances of the marketable subject provided by users of a group, second process 106 may further filter the number of instances to include only relevant instances wherein a timestamp associated with the marketable subject is within a certain period of time. The period of time may include, for example, a predetermined period before a current date or time, or a predetermined period surrounding one or more of timestamps associated with one or more analyzed images. In one example, second process 106 identifies a mean time for all instances of a marketable subject detected for the group of users, and then select as the period of time a period corresponding to a standard deviation from the mean time.

In one or more implementations, second process 106 is configured to identify a current trend 109 for a group of users based on the determined popularity and the previously described time period for the digital images. Accordingly, a current trend for a marketable subject within a group may be identified, for example, when a threshold number of relevant instances are reached for the group. In this regard, the current trend may change periodically, depending on a current period of time and the number of relevant instances of the marketable subject for the current period of time. In various aspects, the current trend may include an indication as to whether the number of relevant instances, or popularity of the marketable subject, is increasing or decreasing within the group. The current trend may further be identified when the increase or decrease greater than a predetermined threshold rate.

Once a trend has been determined for a group of users, second process 106 may determine 110 the value of the trend. The value of the trend may be used to set a value of an offering (e.g., an advertisement) for a vendor of a product or service related to the detected marketable subject. In various implementations, the value is determined for each respective user of the group. Accordingly, second process 106 may determine default value, or a value based on (e.g., proportional) the determined popularity of the marketable subject within a group associated with the user (e.g., the user's “friends”).

In one or more implementations, the value may be determined, or adjusted, based on a level of relevancy of the marketable subject to the user. One or more interests of the user may be determined based on one or more activities of the user in the social network (e.g., through postings, endorsements, views, clicks, and the like). A relationship between the marketable subject and the one or more interests may then be identified, and the level of relevancy between the user and the marketable subject determined based on the strength of that relationship. Additionally, the level of relevancy between a user and the marketable subject may also be used to determine whether an instance of the marketable subject provided by the user to the social network is a relevant instance.

Once a trend has been determined for the group of users, one or more vendors related to the marketable subject may be notified 111 that the current trend applies to one or more of the group of users. For example, where the marketable subject is a specific product or service, the notified vendors may include vendors of the product or service, or vendors who provide competing products or services.

Vendors may be notified on satisfaction of one or more predetermined conditions. For example, a vendor may be notified when the current trend deviates from an initial trend. A deviation or change may include, for example, the popularity increasing beyond a certain amount in a certain period of time (e.g., a product previously detected in 5% of images now detected in 15% of images within 5 hours), or has changed from a previous rise to decreasing in popularity.

The subject technology may include a user interface 112 for notifying vendors of trends and user groups relating to those trends. A vendor may use interface 112 to identify trends related to products or services offered by the vendor, identify users associated with those trends, and to purchase advertising placement within the social network for display to one or more identified users. The cost of placing an advertisement may be set, for example, based on a previously determined value for a selected user or group. The value may further be based on how relevant the trend is to an identified user (e.g., measured by the relationship between the user and the marketable subject). Accordingly, interface 112 provides vendors the ability to purchase and provide advertisements and other offerings for display to selected users.

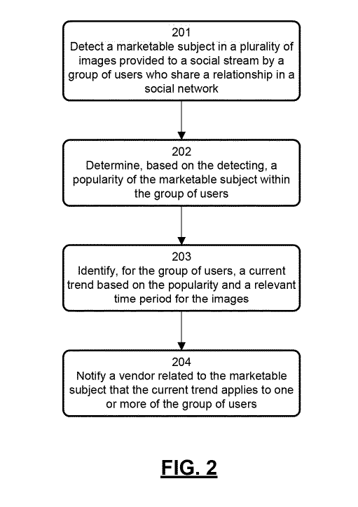

FIG. 2 is a flowchart illustrating an example process for detecting trends from images uploaded to a social network, according to one or more aspects of the subject technology. The blocks of FIG. 2 do not need to be performed in the order shown. It is understood that the depicted order is an illustration of one or more example approaches, and are not meant to be limited to the specific order or hierarchy presented. The blocks may be rearranged, and/or two or more of the blocks may be performed simultaneously.

According to one or more implementations, one or more blocks of FIG. 2 may be executed by machine or computing device executing first process 101 and/or second process 106. Similarly, a non-transitory machine-readable medium may include machine-executable instructions thereon that, when executed by a machine or computing device perform the blocks of FIG. 2. Accordingly, the blocks of FIG. 2 may be performed in association with a social network, specifically a social stream wherein users may upload and share digital images.

In block 201, a process (e.g., operating on one or more computing devices) detects a marketable subject in a plurality of images provided to a social stream by a group of users who share a relationship in a social network. The marketable subject may be a brand identity, style of clothing, or a business establishment. As described previously, the marketable subject may be detected in various ways, including by image recognition. In some aspects, meta data embedded in the image may include one or more marketable subjects, and the subject technology may categorize images uploaded to the social network based on a marketable subject(s) identified within this meta data.

The group of users may be determined from the perspective of a single user using the social network, or by analyzing sets of users, for example, in a geographic location or sharing a common interest. In one example, information is provided to the social network by users through social activity, including posts, endorsements, hyperlinking, and the like. This information may then be analyzed to correlate users based on common interests identified through the information. The group of users identified for detection of a marketable subject may then be based on the users who share a common interest or a subset of those users (e.g., in a geographic area).

In block 202, a popularity of the marketable subject within the group of users is determined based on the detecting of block 202. The popularity may be, for example, how many users in the group uploaded one or more images that include the marketable subject, or how many instances of the marketable subject have been uploaded within a predetermined time period (e.g., in the last hour).

In block 203, a current trend is identified for the group of users based on the popularity and a relevant time period for the images. In various aspects, an instance in time for the marketable subject may be determined for each image, and the current trend identified when a threshold number of the images include an instance in time within the relevant time period. Additionally or in the alternative, the current trend may be identified based on a threshold number of the group of users uploading respective images that depict the detected marketable subject, or based on the respective images being uploaded within a predetermined time period.

In block 204, a vendor related to the marketable subject is notified that the current trend applies to one or more of the group of users. In one or more implementations, the group of users may only include those users who are previously determined to have interests that are relevant to the marketable subject. In other words, even if a user uploads an image pertaining to a marketable subject, that user may not be particularly interested in the marketable subject. In this regards, the subject technology may determine a level of relevancy of the marketable subject to each user based on, for example, social activity and information provided by the user. If the interests of the user are found to reasonably match a demographic for the marketable subject then the marketable subject may be deemed relevant to the user. In some aspects, the level of relevancy of the marketable subject to the user may be calculated based on the strength of the match, for example, how much of the social activity or information relates to the marketable subject. Accordingly, the vender may be notified that the marketable subject applies to a user when a level of relevancy satisfies a predetermined threshold.

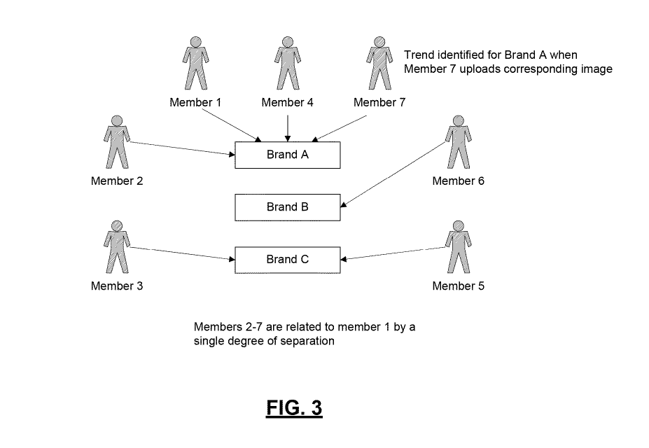

FIG. 3 is a diagram depicting example users of a social network that have uploaded images associated with one or more brands, according to some aspects of the subject technology. In this example, seven identified users of a group have uploaded images that include one or three brands (a marketable subject). Users 2-7 are related to user 1 by a single degree of separation in a social graph, and related to each other by at most two degrees of separation (via user 1).

Users 1, 2, 4, and 7 have uploaded one or more images pertaining to brand A, user 6 has uploaded one or more images pertaining to brand B, and users 3 and 5 have uploaded one or more images pertaining to brand C. Accordingly, the majority of the identified users have uploaded images pertaining to brand A. If all images were uploaded within a predetermined time period for detection of a trend (e.g., within the last day) then the trend may be identified for one of brands A, B, or C. In this example, a majority of brand instances within the predetermined time period determines a trend. Accordingly, if the users uploaded the images in order (1-7) then a current trend for is identified for brand A when user 7 uploads images that pertain to brand A.

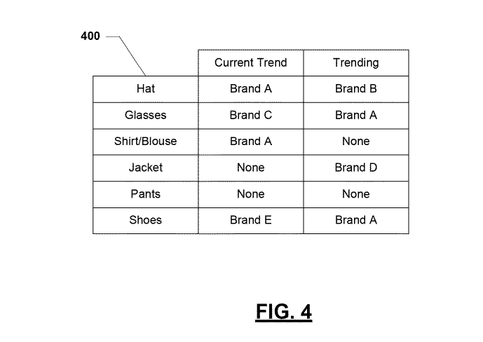

FIG. 4 is an example table 400 of current trends and trending apparel for a prototype user of a social network, according to some aspects of the subject technology. Table 400 is divided into rows, with each row representative of a piece of apparel that a user might wear. While the table depicts certain apparel, it is understood that other types of apparel (or other marketable subjects altogether) may also be included or substituted in table 400, for example, based on types of apparel detected in images uploaded to the social network. Moreover, while table 400 is depicted as a relational table, it is understood that the content of table 400 may be represented or stored in any number of storage technologies.

Each different apparel piece (e.g., hat, glasses, shirt, and the like) is associated in table 300 with a corresponding brand based on an identified trend for the brand within a group. Accordingly, table 300 may be generated for each user of the social network, with the group being those in the user's social graph who share one or more common interests, are connected within one or more degrees of separations, or have been identified to be in a subgroup by the user (e.g., classified as “friends,” “family,” “work,” or the like). When a trend is identified for a particular piece of apparel within the group the “brand” or other identifier is placed in the table to identify the trend. Table 300 includes both current trends and upcoming trends (“trending”) for each type of apparel.

Table 400 may be used to quickly identify trends and trending items for users, and may be joined with other tables associated with users in other groups to identify trends across larger user groups. Table 400, or a derivation of the table, may be displayed to a vendor, for example, in user interface 112, and vendors may user the information in table 400 for remarketing. Thresholds may determine when a trend appears in the table for a particular piece of apparel. For example, if the threshold is more than 15% of users in a group, and the subject technology detects 15% of a user's friends are wearing a certain line of a certain brand's jeans then a vendor for the brand may offer the same style of jeans to another user in the group.

Retailers and manufacturers may use the information in table 400 to see what kind of trends are “hot” and use the information to tailor their product lines and inventory level. Additionally, users may access the table (e.g., in a dashboard) to see what trends are happening throughout their social graph, groups, or the social network to see what products and services other users are wearing, using, driving, and the like to guide their future purchases.

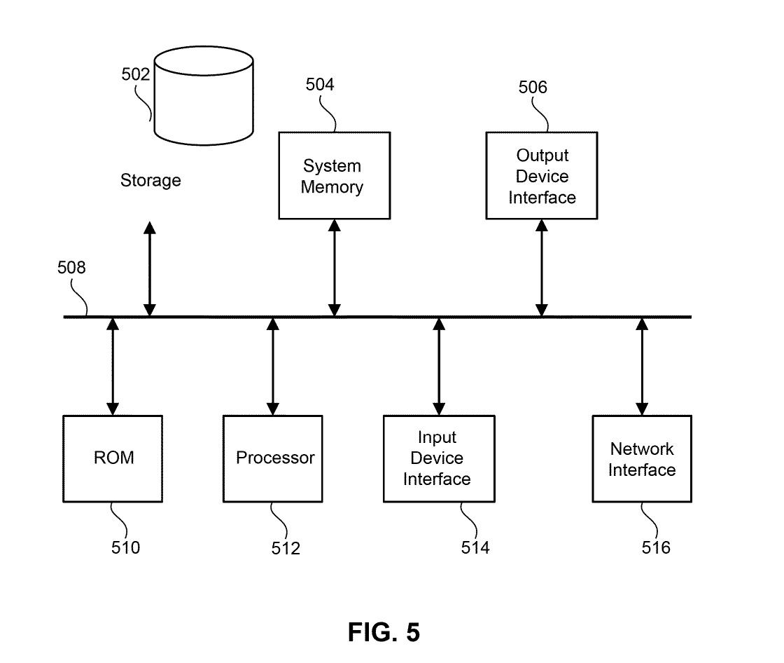

FIG. 5 is a diagram illustrating an example electronic system 500 for use in connection with detecting trends from images uploaded to a social network, according to one or more aspects of the subject technology. Electronic system 500 may be a computing device for execution of software associated with the operation of first process 101 or second process 106. In various implementations, electronic system 500 may be representative of a server, computer, phone, PDA, laptop, tablet computer, touch screen or television with one or more processors embedded therein or coupled thereto, or any other sort of electronic device.

Electronic system 500 may include various types of computer readable media and interfaces for various other types of computer readable media. In the depicted example, electronic system 500 includes a bus 508, processing unit(s) 512, a system memory 504, a read-only memory (ROM) 510, a permanent storage device 502, an input device interface 514, an output device interface 506, and a network interface 516. In some implementations, electronic system 500 may include or be integrated with other computing devices or circuitry for operation of the various components and processes previously described.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The term website, as used herein, may include any aspect of a website, including one or more web pages, one or more servers used to host or store web related content, and the like. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A computer-implemented method, comprising:
detecting a marketable subject in a plurality of images provided to a social stream by a group of users who share a relationship in a social network;
determining, based on the detecting, a popularity of the marketable subject within the group of users;
identifying, for the group of users, a current trend based on the popularity and a relevant time period for the images; and
notifying a vendor related to the marketable subject that the current trend applies to one or more of the group of users.

2. The computer-implemented method of claim 1, wherein the marketable subject is a brand identity, style of clothing, or business establishment.

3. The computer-implemented method of claim 1, further comprising:
determining, for each image, an instance in time for the marketable subject, the current trend being identified when a threshold number of the images include an instance in time within the relevant time period.

4. The computer-implemented method of claim 1, further comprising:
determining user interests based on information provided by the users to the social network; and
determining the relationship based on an interest common to each of the users.

5. The computer-implemented method of claim 1, wherein the relationship is between a user of the group who is actively using the social network and the remaining users in the group.

6. The computer-implemented method of claim 1, wherein the marketable subject is detected in a provided image by image recognition.

7. The computer-implemented method of claim 1, wherein the marketable subject is detected from meta data embedded in a respective image.

8. The computer-implemented method of claim 1, further comprising:
determining a level of relevancy of the marketable subject to the one or more users, wherein the vender is notified when the level of relevancy satisfies a predetermined threshold.

9. The computer-implemented method of claim 8, further comprising:
setting a value of an offering related to the marketable subject based on the level of relevancy; and
providing the value of the offering to the vendor.

10. The computer-implemented method of claim 1, further comprising:
providing a prototype user for a respective user of the group, the prototype user being associated with a plurality of different apparel pieces; and
associating a different brand with each different apparel piece based on an identified trend for the associated brand within the group;
wherein the marketable subject comprises one of the different apparel pieces.

11. The computer-implemented method of claim 1, further comprising:
determining that the current trend comprises a change in an initial trend, the vendor being notified in response to the change.

12. The computer-implemented method of claim 11, further comprising:
sending an offering to at least one of the group of users in response to the change.

13. A machine-readable medium having instructions stored thereon that, when executed, cause a machine to perform a method, the method comprising:
detecting a plurality of marketable subjects in a plurality of images uploaded to a social network, the images uploaded by a group of users who share a relationship in the social network;
identifying, for the group of users, a current trend associated with a detected marketable subject based on a threshold number of instances of the detected marketable subject associated with the group; and
notifying a vendor related to the detected marketable subject that the current trend applies to one or more of the group of users.

14. The machine-readable medium of claim 13, wherein the marketable subject is a brand identity, style of clothing, or business establishment.

15. The machine-readable medium of claim 13, wherein the current trend is identified based on a threshold number of the group of users uploading respective images that depict the detected marketable subject.

16. The machine-readable medium of claim 15, wherein the current trend is identified based on the respective images being uploaded within a predetermined time period.

17. The machine-readable medium of claim 13, wherein the relationship comprises a social connection mutually made between a respective pair of users.

18. The machine-readable medium of claim 13, the method further comprising:
determining a common interest for the group of users based on one or more activities of each of the users in the social network, wherein the relationship shared by the group of users is based on the common interest.

19. The machine-readable medium of claim 13, the method further comprising:
determining one or more interests of a respective user based on information provided to the social network from the user; and
determining that the current trend is relevant to the user based on a relationship between the marketable subject and the provided information,
wherein the vendor is notified that the current trend applies to users to whom the current trend is determined to be relevant.

20. A system, comprising:
one or more processors; and
a memory including instructions that, when executed by the one or more processors, cause the one or more processors to facilitate the steps of:
detecting a marketable subject in a plurality of images provided to a social stream by a group of users who share a relationship in a social network;
determining, based on the detecting, a popularity of the marketable subject within the group of users;
identifying, for the group of users, a current trend based on the popularity and a relevant time period for the images; and
notifying a vendor related to the marketable subject that the current trend applies to one or more of the group of users.
